(19) United States
(12) Patent Application Publication
(10) Pub. No.: US 2026/0271081 A1
(43) Pub. Date: Sep. 10, 2026

(54) METHODS AND APPARATUS FOR REPORTING SN RACH REPORTS IN A WIRELESS COMMUNICATION SYSTEM

(71) Applicant: SAMSUNG ELECTRONICS CO., LTD., Suwon-si, Gyeonggi-do (KR)

(72) Inventors: Aby Kanneath ABRAHAM, Bangalore (IN); Sangyeob JUNG, Suwon-si (KR)

(21) Appl. No.: 19/156,342

(22) PCT Filed: Feb. 13, 2024
(86) PCT No.: PCT/KR2024/001991

§ 371 Date: Aug. 13, 2025

(30) Foreign Application Priority Data
Feb. 13, 2023 (IN) 202341009548
Jan. 30, 2024 (IN) 202341009548

(51) Int. Cl. H04W 74/0833

(52) U.S. Cl. CPC H04W 74/0833

(57) ABSTRACT

The disclosure relates to a 5G or 6G communication system for supporting a higher data transmission rate. Embodiments herein disclose methods for handling a secondary node (SN) random access channel (RACH) reporting in a wireless network (300) by a UE (100). The method includes informing by the UE (100) to a network entity (200), that the UE (100) is capable of a delivery of the at least one SN RACH report to the network entity (200). Further, the method includes receiving a request from the network entity (200). Further, the method includes determining that the UE (100) has stored the at least one SN RACH report. Further, the method includes sending the at least one SN RACH report to the network entity (200) based on the request and the determination.

### TECHNICAL FIELD

Embodiments disclosed herein relate to wireless communication networks, and more particularly to methods and systems for self-optimization (including optimizations for minimization of drive tests) of random access in wireless networks like fifth generation (5G) new radio (NR) and the methods and systems of sending random access information to a network entity by a User Equipment (UE) in NR.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to disclose methods and wireless network for self-optimization (including optimizations for minimization of drive tests) of random access in wireless networks like 5G NR and the methods and systems of sending random access information to a network entity by the UE in a NR.

Another object of the embodiments herein is to disclose methods for reporting of SN RACH reports to MN (eNB, which also may be a ng-eNB) in EN-DC and NG-EN-DC for SON purposes.

### Solution to Problem

Accordingly, the embodiments herein provide methods for handling a secondary node (SN) random access channel (RACH) reporting in a wireless network. The method includes informing, by the UE to a network entity, that the UE is capable of a delivery of the at least one SN RACH report to the network entity. Further, the method includes receiving, by the UE, a request from the network entity. Further, the method includes determining, by the UE, that the UE has stored at least one SN RACH report (i.e. RACH report in a NR cell). Further, the method includes sending, by the UE, the at least one SN RACH report to the network entity based on the request.

In an embodiment, the at least one SN RACH report is a NR RACH report, and the network entity is an eNB.

In an embodiment, the request is a UE Information Request. The UE Information Request is a Long Term Evolution (LTE) radio resource control (RRC) message UEIn-formationRequest. The UE Information Request includes a field to indicate whether the UE reports information about a random access procedure in a SN.

In an embodiment, an information is provided within a list of SON parameters in the UECapabilityInformation LTE RRC message.

In an embodiment, the UE sends the SN RACH report by including a RA report in the SN RACH report in a UE information response, upon reception of the UE information request including a request to send the SN RACH report to the network entity, when the UE has a SN random access related information stored in a NR RRC variable and if a Registered Public Land Mobile Network (RPLMN) is included in a plmn-IdentityList stored in the NR RRC variable.

In an embodiment, the UE sends the SN RACH Report including a list of PSCell identifiers and an OCTET STRING containing a NR RA Report. A list of PSCell identifiers includes a PSCell identity of all cells in a NR RA Report.

In an embodiment, the UE encodes the list of PSCell identifiers in a LTE ASN.1 format. The NR RA report is encoded in a NR ASN.1 format.

In an embodiment, the PSCell identifier includes at least one of: a CellGlobalI-dentifier of the PSCell, a combination of NR PCI and a NR ARFCN of the PSCell where each PSCell identifier is encoded in a LTE ASN.1 format.

Accordingly, the embodiments herein provide methods for handling a SN RACH reporting in a wireless network. The method includes sending, by a first network entity, a request to a UE. Further, the method includes receiving, by the first network entity, the SN RACH report from the UE based on the request. Further, the method includes forwarding, by the first network entity, the received SN RACH reporting to at least one second network entity. The received SN RACH reporting includes at least one PSCell in a list of PSCell identifiers. Further, the method includes receiving and decoding, by the second network entity, the SN RACH reporting. Further, the method includes performing, by the by the second network entity, a self-optimization for at least one PSCell belonging to the second network entity.

In an embodiment, the second network entity is the gNB and the first network entity (200) is an eNB.

Accordingly, the embodiments herein provide a UE including a SN RACH reporting controller coupled with a processor and a memory. The SN RACH reporting controller is configured to inform to a network entity, that the UE is capable of a delivery of the at least one SN RACH report to the network entity. Further, the SN RACH reporting controller is configured to receive a request from a network entity. Further, the SN RACH reporting controller is configured to determine that the UE has stored at least one SN RACH report. Further, the SN RACH reporting controller is configured to send the at least one SN RACH report to the network entity based on the request and the determination.

Accordingly, the embodiments herein provide a wireless network including a first network entity and a second network entity. The first network entity includes a SN RACH reporting controller coupled with a processor and a memory. The SN RACH reporting controller is configured to send a request to a UE. Further, the SN RACH reporting controller is configured to receive the SN RACH reporting in a SON parameter from the UE based on the request. Further, the SN RACH reporting controller is configured to forward the received SN RACH reporting to at least one second network entity. The received SN RACH reporting includes at least one PSCell in a list of PSCell identifiers. Further, the second network entity receives and decodes the SN RACH reporting. Further, the second network entity performs the self-optimization for at least one PSCell belonging to the second network entity.

In an embodiment, a method of a user equipment (UE) in a communication system is comprising: receiving, from a base station, a request message including a field indicating whether the UE reports new radio (NR) random access channel (RACH) information; identifying, whether the UE supports a report of the NR RACH information, as a response to the request message; and in case that the field is set true, and in case that the NR RACH information is stored and in case that a public land mobile networks (PLMN) identity (ID) list is stored, transmitting, to the base station, a response message including the NR RACH information.

In an embodiment, a method of a base station in a communication system, the method comprising: transmitting, to a user equipment (UE), a request message including a field indicating whether the UE reports new radio (NR) random access channel (RACH) information; and in case that the field is set true, and in case that the NR RACH information is stored in the UE and in case that a public land mobile networks (PLMN) identity (ID) list is stored in the UE, receiving, from the UE, a response message including the NR RACH information; wherein whether the UE supports a report of the NR RACH information is identified, as a response to the request message.

In an embodiment, a user equipment (UE) in a communication system, the UE comprising: a transceiver, and a controller coupled with the transceiver configured to: receive, from a base station, a request message including a field indicating whether the UE reports new radio (NR) random access channel (RACH) information; identify, whether the UE supports a report of the NR RACH information, as a response to the request message; and in case that the field is set true, and in case that the NR RACH information is stored and in case that a public land mobile networks (PLMN) identity (ID) list is stored, transmit, to the base station, a response message including the NR RACH information.

In an embodiemt, a base station in a communication system, the base station comprising: a transceiver, and a controller coupled with the transceiver configured to: transmit, to a user equipment (UE), a request message including a field indicating whether the UE reports new radio (NR) random access channel (RACH) information; and in case that the field is set true, and in case that the NR RACH information is stored in the UE and in case that a public land mobile networks (PLMN) identity (ID) list is stored in the UE, receive, from the UE, a response message including the NR RACH information; wherein whether the UE supports a report of the NR RACH information is identified, as a response to the request message.

These and other aspects of the embodiments herein will be better appreciated and understood when considered in conjunction with the following description and the accompanying drawings. It should be understood, however, that the following de-scriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to an embodiment of the disclosure, a wireless communication can be performed efficiently. Especially, a reporting SN RACH reports can be performed efficiently.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for handling a SN RACH reporting, according to the embodiments as disclosed herein;

FIG. 2 shows various hardware components of a UE, according to the embodiments as disclosed herein;

FIG. 3 shows various hardware components of a network entity, according to the embodiments as disclosed herein;

FIG. 4 is a flow chart illustrating a method, implemented by the UE, for handling the SN RACH reporting in the wireless network, according to the embodiments as disclosed herein;

FIG. 5 is a flow chart illustrating a method for handling the SN RACH reporting in the wireless network, according to the embodiments as disclosed herein;

FIG. 6 is a flowchart depicting the process of reporting SN RACH information to the eNB, according to embodiments as disclosed herein; and

FIG. 7 is a flowcharts depicting the process of generating and reporting SN RACH reports, according to embodiments as disclosed herein.

FIG. 8 is a flowcharts depicting the process of generating and reporting SN RACH reports, according to embodiments as disclosed herein.

FIG. 9 is a flowcharts depicting the process of generating and reporting SN RACH reports, according to embodiments as disclosed herein.

### MODE FOR THE INVENTION

RACH: In the 5G wireless communication system, random access (RA) is supported. The RA is used to achieve uplink (UL) time synchronization. The RA is used during initial access, handover, radio resource control (RRC) connection re-establishment procedure, scheduling request transmission, secondary cell group (SCG) addition/modification, beam failure recovery and data or control information transmission in the UL by non-synchronized UE in a RRC CONNECTED state. Several types of random access procedure are supported.

Contention Based Random Access (CBRA): In this type of random access, a UE first transmits Random Access preamble (also referred as Msg1) and then waits for Random access response (RAR) in a RAR window. The RAR is also referred as Msg2. The Next generation node B (gNB) transmits the RAR on a physical downlink shared channel (PDSCH). A PDCCH (physical downlink control channel) scheduling the PDSCH carrying RAR is addressed to RA-radio network temporary identifier (RA-RNTI). The RA-RNTI identifies the time-frequency resource (also referred as physical RA channel (PRACH) occasion or PRACH transmission (TX) occasion or RA channel (RACH) occasion) in which RA preamble was detected by the gNB. If the RAR corresponding to its RA preamble transmission is received, the UE transmits message 3 (Msg3) in a UL grant received in the RAR. The Msg3 includes message such as RRC connection request, RRC connection re-establishment request, RRC handover confirm, scheduling request, SI request etc. It may include the UE identity (i.e., cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a physical downlink control channel (PDCCH) addressed to C-RNTI included in Msg3, contention resolution is considered successful, contention resolution timer is stopped and the RA procedure is completed. While the contention resolution timer is running, if the UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and the UE has not yet transmitted the RA preamble for a configurable number of times, the UE goes back to the first step; i.e., select random access resource (preamble/RACH occasion) and transmits the RA preamble. A backoff may be applied before going back to first step.

Contention Free Random Access (CFRA): This is also referred as legacy CFRA or 4 step CFRA. The CFRA procedure is used for scenarios such as handover where low latency is required, timing advance establishment for secondary cell (Scell), etc. A 5G node B (gNB) assigns to UE dedicated Random access preamble. The UE transmits the dedicated RA preamble. The gNB transmits the RAR on PDSCH addressed to RA-RNTI. The RAR conveys RA preamble identifier and timing alignment information. The RAR may also include UL grant. The RAR is transmitted in a RAR window similar to contention based RA (CBRA) procedure. CFRA is considered successfully completed after receiving the RAR including RA preamble identifier (RAPID) of RA preamble transmitted by the UE. If RA is initiated for beam failure recovery, the CFRA is considered successfully completed if PDCCH addressed to C-RNTI is received in search space for beam failure recovery. If the RAR window expires and RA is not successfully completed and the UE has not yet transmitted the RA preamble for a configurable (configured by gNB in RACH configuration) number of times, the UE retransmits the RA preamble.

2 Step Contention Based Random Access (2 Step CBRA): In the first step, the UE transmits random access preamble on PRACH and a payload (i.e. MAC PDU) on PUSCH. The random access preamble and payload transmission is also referred as MsgA. In the second step, after MsgA transmission, the UE monitors for a response from the network (i.e., gNB) within a configured window. The response is also referred as/MsgB. If CCCH SDU was transmitted in MsgA payload, the UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if the UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, the UE transmits Msg3 and performs contention resolution using Msg4 as in CBRA procedure. If contention resolution is successful, random access procedure is considered successfully completed. If contention resolution fails upon fallback (i.e., upon transmitting Msg3), the UE retransmits MsgA. If the configured window in which UE monitors the network response after transmitting MsgA expires and the UE has not received MsgB including contention resolution information or fallback information as explained above, the UE retransmits MsgA. If the random access procedure is not successfully completed even after transmitting the msgA configurable number of times, the UE fallbacks to 4 step RACH procedure; i.e., UE only transmits the PRACH preamble.

2 Step Contention Free Random Access (2 Step CFRA): In this case, the gNB assigns to the UE dedicated Random access preamble(s) and PUSCH resource(s) for MsgA transmission. RACH Occasions RO(s) to be used for preamble transmission may also be indicated. In the first step, the UE transmits random access preamble on PRACH and a payload on PUSCH using the contention free random access resources (i.e., dedicated preamble/PUSCH resource/RO). In the second step, after MsgA transmission, the UE monitors for a response from the network (i.e., gNB) within a configured window. If the UE receives PDCCH addressed to C-RNTI, random access procedure is considered successfully completed. If the UE receives fallback information corresponding to its transmitted preamble, random access procedure is considered successfully completed.

Dual Connectivity: Dual connectivity or more technically multi-radio dual connectivity is specified by 3GPP in specifications such as TS 37.340. A summary of the details on dual connectivity and measurement gap operations with dual connectivity are given below.

NG-RAN supports Multi-Radio Dual Connectivity (MR-DC) operation whereby the UE in an RRC_CONNECTED is configured to utilize radio resources provided by two distinct schedulers, located in two different NG-RAN nodes connected via a non-ideal backhaul, one providing NR (New Radio) access and the other one providing either E-UTRA (Evolved UMTS Terrestrial Radio Access) or NR access. One node acts as the master node (MN) and the other as the secondary node (SN). The MN and SN are connected via a network interface and at least the MN is connected to the core network. NG-RAN supports NG-RAN E-UTRA-NR Dual Connectivity (NGEN-DC), in which the UE is connected to one ng-eNB (a E-UTRA base station that can connect to 5G core) that acts as a MN and one gNB (5G base station) that acts as a SN. NG-RAN also supports NR-E-UTRA Dual Connectivity (NE-DC), in which the UE is connected to one gNB that acts as a MN and one ng-eNB that acts as a SN.

Self-Optimization in NR: A 5G NR (new radio) radio access network also known as NG-RAN (Next Generation Radio Network) comprises of a number of NR base stations knows as gNBs. The gNBs can be connected to each other through the Xn interface, and will be connected to various core network elements like the AMF (Access and Mobility Management Function), the UPF (User Plane Function) etc. Further, the gNBs can be divided into two physical entities; named CU (Centralized Unit) and DU (Distributed Unit). The CU provides support for the higher layers of the protocol stack such as SDAP (Session Data Application Protocol), PDCP (Packet Data Convergence Protocol) and RRC (Radio Resource Control). The DU provides support for the lower layers of the protocol stack such as RLC (Radio Link Control), MAC (Medium Access Control) and Physical layer. Each gNB can have multiple cells serving many UEs (User Equipment). There are a large number of algorithms and configuration parameters used in NG-RAN. Especially, it is a very difficult task to identify the most optimal radio parameters and operators used to resort to manual techniques like drive tests to identify the parameters. However, such manual parameter tuning is a costly operation since it depends on a lot of factors like the number of users, number of neighbors, maximum throughput in the cell, average throughput in the cell etc. Further, whenever a neighbor gNB is installed or a new service is introduced, many of these manual operations need to be repeated. To resolve this problem, 3gpp has introduced Self-Organizing Networks (SON) techniques in the wireless technologies like NR. SON was first introduced in 3gpp release 9, in LTE. SON solutions can be divided into three categories: Self-Configuration, Self-Optimization and Self-Healing. The SON architecture can be a centralized, distributed or a hybrid solution.

Self-optimization of RACH aims to minimize the number of attempts on the RACH. UE can report the detailed information about RACH in the RACH Report to the network and the network will optimize various parameters associated with RACH using the information. A List of information that the UE could report in RACH is given as below based on NR TS 38.331

RA-ReportList-r16 ::= SEQUENCE (SIZE (1..max RAReport-r16)) OF RA-
Report-r16

| | |
|---|---|
| RA-Report-r16 ::= | SEQUENCE { |
| cellId-r16 | CHOICE { |
| cellGlobalId-r16 | CGI-Info-Logging-r16, |
| pci-arfcn-r16 | SEQUENCE { |
| physCellId-r16 | PhysCellId, |
| carrierFreq-r16 | ARFCN-ValueNR |

```
    }
  },
```

| | |
|---|---|
| ra-InformationCommon-r16 | RA-InformationCommon-r16 |

OPTIONAL,

| | |
|---|---|
| raPurpose-r16 | ENUMERATED {accessRelated, |

beamFailureRecovery, reconfigurationWithSync, ulUnSynchronized,

schedulingRequestFailure,

noPUCCHResourceAvailable, requestForOtherSI,

spare9, spare8, spare7, spare6, spare5, spare4,

spare3, spare2, spare1},
...
}

| RA-InformationCommon-r16 ::= | SEQUENCE { | |
|---|---|---|
| absoluteFrequencyPointA-r16 | ARFCN-ValueNR, | |
| locationAndBandwidth-r16 | INTEGER (0..37949), | |
| subcarrierSpacing-r16 | SubcarrierSpacing, | |
| msg1-FrequencyStart-r16 | | INTEGER |
| (0..maxNrofPhysicalResourceBlocks-1) | OPTIONAL, | |
| msg1-FrequencyStartCFRA-r16 | | INTEGER |
| (0..maxNrofPhysicalResourceBlocks-1) | OPTIONAL, | |
| msg1-SubcarrierSpacing-r16 | SubcarrierSpacing | OPTIONAL, |

| | |
|---|---|
| msg1-SubcarrierSpacingCFRA-r16 | SubcarrierSpacing |

OPTIONAL,

| | |
|---|---|
| msg1-FDM-r16 | ENUMERATED {one, two, four, eight} |

OPTIONAL,

| | |
|---|---|
| msg1-FDMCFRA-r16 | ENUMERATED {one, two, four, eight} |

OPTIONAL,

| | |
|---|---|
| perRAInfoList-r16 | PerRAInfoList-r16, |

```
  ...,
  [[
```

| | |
|---|---|
| perRAInfoListExt-v1660 | PerRAInfoListExt-v1660 |

OPTIONAL

]],

[[

| | |
|---|---|
| msgA-FrequencyStart-r17 | INTEGER |

| | |
|---|---|
| (0..maxNrofPhysicalResourceBlocks-1) | OPTIONAL, |

| | |
|---|---|
| msgA-FrequencyStartCFRA-r17 | INTEGER |

| | |
|---|---|
| (0..maxNrofPhysicalResourceBlocks-1) | OPTIONAL, |

| | |
|---|---|
| msgA-SubcarrierSpacing-r17 | SubcarrierSpacing |

OPTIONAL,

| | |
|---|---|
| msgA-SubcarrierSpacingCFRA-r17 | SubcarrierSpacing |

OPTIONAL,

| | |
|---|---|
| msgA-FDM-r17 | ENUMERATED {one, two, four, eight} |

OPTIONAL,

| | |
|---|---|
| msgA-FDMCFRA-r17 | ENUMERATED {one, two, four, eight} |

OPTIONAL,

| | |
|---|---|
| measuredDL-RSRP-r17 | RSRP-Range |

OPTIONAL,

| | |
|---|---|
| msgA-TransMax-r17 | ENUMERATED {n1, n2, n4, n6, n8, n10, |

| | |
|---|---|
| n20, n50, n100, n200} | OPTIONAL |

| | | |
|---|---|---|
| msgA-MCS-r17 | INTEGER (0..15) | OPTIONAL, |

| | |
|---|---|
| nrofPRBs-PerMsgA-PO-r17 | INTEGER (1..32) |

OPTIONAL,

| | |
|---|---|
| msgA-PUSCH-TimeDomainAllocation-r17 | INTEGER (1..maxNrofUL- |

| | |
|---|---|
| Allocations) | OPTIONAL, |

| | |
|---|---|
| frequencyStartMsgA-PUSCH-r17 | INTEGER |

| | |
|---|---|
| (0..maxNrofPhysicalResourceBlocks-1) | OPTIONAL, |

| | |
|---|---|
| nrofMsgA-PO-FDM-r17 | ENUMERATED {one, two, four, eight} |

OPTIONAL,

| | | |
|---|---|---|
| dlPathlossRSRP-r17 | RSRP-Range | OPTIONAL, |

| | |
|---|---|
| intendedSIBs-r17 | SEQUENCE (SIZE (1..maxSIB)) OF SIB-Type- |

r17 OPTIONAL,

| | |
|---|---|
| ssbsForSI-Acquisition-r17 | SEQUENCE (SIZE (1..maxNrofSSBs-r16)) |

| | |
|---|---|
| OF SSB-Index | OPTIONAL, |

| | |
|---|---|
| msgA-PUSCH-PayloadSize-r17 | BIT STRING (SIZE (3)) |

OPTIONAL,

| | | |
|---|---|---|
| onDemandSISuccess-r17 | BOOLEAN | OPTIONAL |

]]
}
PerRAInfoList-r16 ::= SEQUENCE (SIZE (1..200)) OF PerRAInfo-r16
PerRAInfoListExt-v1660 ::= SEQUENCE (SIZE (1..200)) OF PerRACSI-
RSInfoExt-v1660

| | |
|---|---|
| PerRAInfo-r16 ::= | CHOICE { |
| perRASSBInfoList-r16 | PerRASSBInfo-r16 |
| perRACSI-RSInfoList-r16 | PerRACSI-RSInfo-r16 |

}

| | |
|---|---|
| PerRASSBInfo-r16 | SEQUENCE { |
| ssb-Index-r16 | SSB-Index, |
| numberOfPreamblesSentOnSSB-r16 | INTEGER (1..200), |
| perRAAttemptInfoList-r16 | PerRAAttemptInfoList-r16 |

}

| | |
|---|---|
| PerRACSI-RSInfo-r16 ::= | SEQUENCE { |
| csi-RS-Index-r16 | CSI-RS-Index, |
| numberOfPreamblesSentOnCSI-RS-r16 | INTEGER (1..200) |

}

| PerRACSI-RSInfoExt-v1660 ::= | SEQUENCE { | |
|---|---|---|
| csi-RS-Index-v1660 | INTEGER (1..96) | OPTIONAL |

}

| | |
|---|---|
| PerRAAttemptInfoList-r16 ::= | SEQUENCE (SIZE (1..200)) OF |

PerRAAttemptInfo-r16

| PerRAAttemptInfo-r16 ::= | SEQUENCE { | |
|---|---|---|
| contentionDetected-r16 | BOOLEAN | OPTIONAL, |
| dlRSRPAboveThreshold-r16 | BOOLEAN | OPTIONAL, |

...,
[[

| | | |
|---|---|---|
| fallbackRAR-Received-r17 | BOOLEAN | OPTIONAL |

]]
}

The UE sends RACH reports to the network in RRC messages, for example, UE Information Response. On receiving the RACH report, the gNB CU may send it to the gNB DU or the OAM SON module or may directly use it for optimizing various parameters related to random access. For example, the number of preambles, configuration of group A and group B preambles, RACH prioritization information, contention resolution timer, number of RACH preambles for 2 step RACH, PUSCH related parameters for 2 step RACH etc.

For the optimization of RACH in SN (NR cell), the UE sends SN RA Report for EN-DC and (NG) EN-DC to the MN and MN forwards the RA report to the SN.

3GPP V17.3.0 version of TS 38.331, TS 38.306, TS 38.300, TS 36.331 and TS 36.306 are considered as relevant background.

The above information is presented as background information only to help the reader to understand the present invention. Applicants have made no determination and make no assertion as to whether any of the above might be applicable as prior art with regard to the present application.

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve methods for handling a SN RACH reporting in a wireless network. The method includes informing, by the UE to a network entity, that the UE is capable of a delivery of the at least one SN RACH report to the network entity. Further, the method includes receiving, by the UE, a request from the network entity. Further, the method includes determining, by a UE, that the UE has stored at least one SN RACH report. Further, the method includes sending, by the UE, the at least one SN RACH report to the network entity based on the request.

The method can be used for self-optimization (including optimizations for minimization of drive tests) of random access in the wireless networks. The methods can be used to send the random access information to the network by the UE in NR. The methods can be used for reporting of SN RACH reports to MN in EN-DC and NG-EN-DC for SON purposes.

The proposed method helps in optimization of NR random access. Unless the UE reports, the NR random access information to the eNB, the gNB can retrieve this information only when the UE connects to any gNB in a stand-alone mode. This delays retrieval of information and thus delays optimisation. In some cases, this information may also be lost since UE discards the reports after a certain time, thereby preventing the optimization itself.

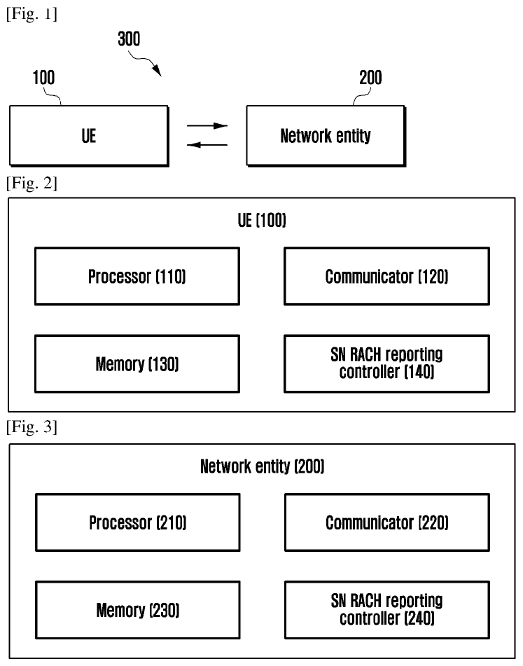

Referring now to the drawings, and more particularly to FIGS. 1 through 9, where similar reference characters denote corresponding features consistently throughout the figures, there are shown at least one embodiment.

FIG. 1 illustrates a wireless network (300) for handling a SN RACH reporting, according to the embodiments as disclosed herein. In an embodiment, the wireless network (300) includes a UE (100) and a network entity (200). The wireless network (300) can be, for example, but not limited to a fourth generation (4G) network, a fifth generation (5G) network, a 6G network, an Open Radio Access Network (ORAN) or the like.

The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network entity (200) can be, for example, but not limited to a gNB, a eNB, a new radio (NR) trans-receiver or the like.

The UE (100) determines that the UE (100) has stored at least one SN RACH report. Based on the determination, the UE (100) informs to the network entity (200) that the UE (100) is capable of a delivery of the at least one SN RACH report to the network entity (200). Further, the UE (100) receives the request from a network entity (200). Further, the UE (100) sends the SN RACH report to the network entity (200) based on the request.

In an embodiment, the UE (100) which supports SN RACH reporting for EN-DC/NG-EN-DC, informs the eNB that it is capable of the delivery of SN RACH reports upon the request from the network (as specified in the below embodiments).

An example specification extract of TS 36.306 is given below:
4.3.12 SON parameters
4.3.12.4 rach-Report-r18

This field indicates whether the UE (100) supports delivery of SN RACHReport upon request from the network

Configuration: In an embodiment, the network entity (200) (e.g., eNB or the like) includes a flag in the UE Information Request (e.g., LTE RRC message UEInforma-tionRequest or the like) to request the UE (100) to send the SN RACH Report to the network entity (200) (e.g., eNB).

An example specification extract of TS 36.331 is given below:

| | | |
|---|---|---|
| UEInformationRequest-r9 | ::= | SEQUENCE { |

| | |
|---|---|
| rrc-TransactionIdentifier | RRC-TransactionIdentifier, |

| | |
|---|---|
| criticalExtensions | CHOICE { |
| cl | CHOICE { |

```
      ueInformationRequest-r9
  UEInformationRequest-r9-IEs,
      spare3 NULL, spare2 NULL, spare1 NULL
    },
```

| | |
|---|---|
| criticalExtensionsFuture | SEQUENCE { } |

}
}
UEInformationRequest-v1710-IEs ::= SEQUENCE {

| | |
|---|---|
| coarseLocationReq-r17 | ENUMERATED |

| | |
|---|---|
| {true} | OPTIONAL, -- Need ON |

| | |
|---|---|
| nonCriticalExtension | UEInformationRequest- |
| v18XX-IEs | OPTIONAL |

}
UEInformationRequest-v18XX-IEs ::= SEQUENCE {

| | |
|---|---|
| SN-rach-reportreq | ENUMERATED |

| | |
|---|---|
| {true} | OPTIONAL, -- Need ON |

| | |
|---|---|
| nonCriticalExtension | SEQUENCE { } |

OPTIONAL

}

UEInformationRequest field descriptions

coarseLocationReq
This field is used to request UE to report coarse location information.
rach-ReportReq
This field is used to indicate whether the UE shall report information
about the random access procedure.
SN-rach-reportreq
This field is used to indicate whether the UE shall report information
about the random access procedure in SN

Upon reception of UE InformationRequest including SN-rach-reportreq, if the UE (100) has SN random access related information stored in NR RRC variable VarRA-Report and if the RPLMN (Registered Public Land Mobile Network) is included in plmn-IdentityList stored in VarRA-Report, the UE (100) sends the SN RA report by including the RA reports in the VarRA-Report in the SN RACH Report in the UE Information Response. The UE (100) sends the SN RACH Report in the UE Information Response through one of the below methods.

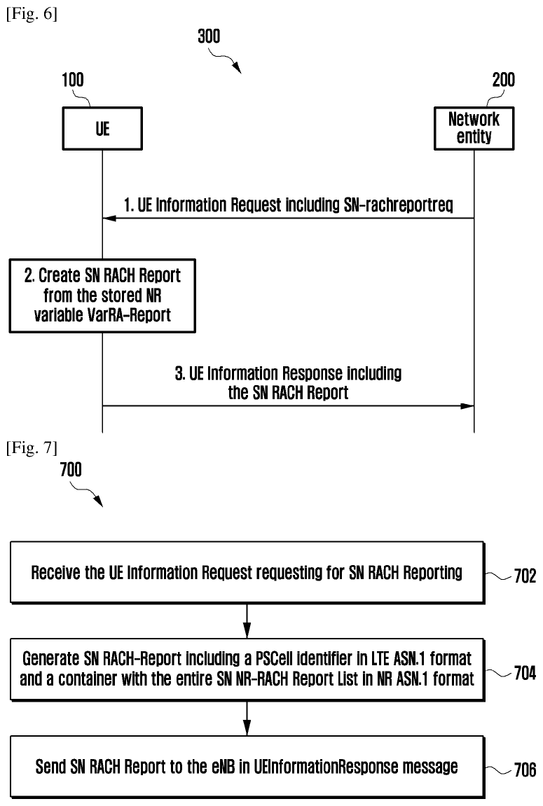

SN RACH Reporting: In an embodiment, the UE (100) which has stored the list of SN RACH reports (i.e. NR RACH reports) in the EN-DC, sends the list of SN RACH reports to the MN (i.e., eNB) upon the request of the eNB. It is also possible to send the list of NR RACH reports to eNB while eNB is in the stand-alone (SA) mode. Further, it may be also possible to send the NR RACH reports to the eNB wherein the NR RACH reports are stored for the random accesses in stand-alone (SA) mode. In an embodiment, the UE (100) sends the SN RACH-Report in the LTE RRC UE Information Response message to the network entity (200) (e.g., eNB or the like). In an embodiment, the UE (100) includes one or more octet strings to carry the SN RACH report. FIG. 6 is a flowchart depicting the process of reporting SN RACH information to the network entity (200) (e.g., eNB or the like)

In an embodiment, the UE (100) includes each NR (SN) RA report as a container associated with one PSCell identity. The UE (100) encodes PSCell identity in LTE ASN.1 format and the SN random access report is encoded in NR ASN.1 format. FIG. 7 is a flowchart depicting the process of generating and reporting SN RACH reports.

The PSCell identity is a choice containing CellGlobalIdNR as in LTE R16 ASN.1 or the NR PCI and ARFCN. In an embodiment, the PSCell identity is the cell identifier of the current PSCell of the UE (100). In an embodiment, the PSCell identity is the cell identifier for the first RA Report in the ra-reportList in NR RRC variable VarRA-Report. In an embodiment, the PSCell identity is the cell identifier for the cell with maximum number of RA Reports in the ra-reportList in NR RRC variable VarRA-Report.

An example ASN.1 format for SN RACH Report according to LTE TS 36.331 is given below.

| | |
|---|---|
| UEInformationResponse-r9-IEs ::= | SEQUENCE { |

| | |
|---|---|
| rach-Report-r9 | RACH- |

| | |
|---|---|
| Report-r16 | OPTIONAL, |

| | |
|---|---|
| rlf-Report-r9 | RLF-Report-r9 |

OPTIONAL,

nonCriticalExtension

| | |
|---|---|
| UEInformationResponse-v930-Ies | OPTIONAL |

}
UEInformationResponse-v1710-Ies ::= SEQUENCE {

| | |
|---|---|
| coarseLocationInfo-r17 | OCTET STRING |

OPTIONAL, nonCriticalExtension

```
    UEInformationResponse-v18xx-Ies
    OPTIONAL
}
UEInformationResponse-v18xx-Ies ::= SEQUENCE {
    sn-rach-report-r18 SN-RACH-Report-r18 OPTIONAL,
```

| | |
|---|---|
| nonCriticalExtension | SEQUENCE { } |

OPTIONAL

}

| | |
|---|---|
| SN-RACH-Report-r18 ::= | SEQUENCE { |
| nr-CellId-r17 | CHOICE { |

| | |
|---|---|
| CellGlobalIdNR | CellGlobalIdNR-r16, |

| | |
|---|---|
| pci-arfcn-r18 | PCI-ARFCN-NR-r18 |

},

| | |
|---|---|
| NR-RA-Report | OCTET STRING, |

}

The NR-RA-Report container contains an OCTET STRING which contains the entire SN NR-RACH Report List. Upon reception of UE Information request requesting for the reporting of SN RACH Report, the UE (100) sets NR-RA-Report to an OCTET STRING containing the contents of ra-reportList in NR RRC variable VarRA-Report encoded in NR ASN.1 format.

Upon receiving the SN RACH-Report, the eNB forwards the received RACH report to the gNB which has the received PSCell. The gNB retrieves and decodes the NR-RACH-Report send by the eNB and performs self-optimization for the PSCells belonging to the gNB. The gNB also retrieves the cell identifier of any other RACH reports in the RACH-ReportList and forwards the corresponding RACH Reports to their gNBs.

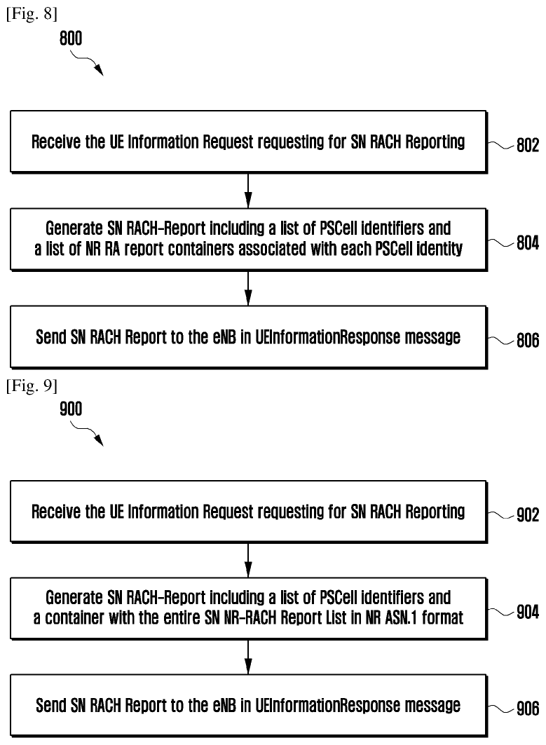

In an embodiment, the UE (100) sends the SN RACH-Report including a list of PSCell identifiers and a list of NR RA report containers associated with each PSCell identity. The UE (100) encodes PSCell identifiers in LTE ASN.1 format and the random access report is encoded in NR ASN.1 format. FIG. 8 is a flowchart depicting the process of generating and reporting SN RACH reports.

Upon receiving the SN RACH-Report, the eNB forwards the received RACH report to the gNB which has the received PSCell. The gNB retrieves and decodes the NR-RACH-Report send by the eNB and performs self-optimization for the PSCells belonging to the gNB. The gNB also retrieves the cell identifier of any other RACH reports in the RACH-ReportList and forwards the corresponding RACH Reports to their gNBs.

An example ASN.1 format for reporting SN RACH Reports according to LTE TS 36.331 based on above embodiment is given below.

UEInformationResponse-v1710-Ies ::= SEQUENCE {

| | |
|---|---|
| coarseLocationInfo-r17 | OCTET STRING |

OPTIONAL, nonCriticalExtension

```
    UEInformationResponse-v18xx-Ies
    OPTIONAL
}
UEInformationResponse-v18xx-Ies ::= SEQUENCE {
    sn-rach-report-List-r18 SEQUENCE (SIZE
    (1..maxNrofSNRAReport) OF
SN-RACH-Report-r18 OPTIONAL,
```

| | |
|---|---|
| nonCriticalExtension | SEQUENCE { } |

OPTIONAL

}

| | |
|---|---|
| SN-RACH-Report-r18 ::= | SEQUENCE { |
| nr-CellId-r18 | CHOICE { |

| | |
|---|---|
| CellGlobalIdNR | CellGlobalIdNR-r16, |

| | |
|---|---|
| pci-arfcn-r18 | PCI-ARFCN-NR-r18 |

},

| | |
|---|---|
| NR-RA-Report | OCTET STRING, |

}
maxNrofSNRAReport := 8

The NR-RA-Report container contains an OCTET STRING which contains the SN NR-RACH Report List associated with a PSCell identifier in SN-RACH-Report-r18 (random access performed in the PSCell with the identifier as nr-CellId-r18); i.e., the list of RACH reports (for e.g., a list of NR IE RA-Report-r16) for the random access in the PSCell identified by the PSCell identifier.

Upon reception of UE Information request requesting for the reporting of SN RACH Report, the UE (100) sets the value of NR-RA-Report mapped to each PSCell, to an OCTET STRING containing the contents of the list of one or more NR ra-report for the random access of the associated PSCell within the NR ra-reportList in NR RRC variable VarRA-Report, encoded in NR ASN.1 format. The UE (100) includes the cell identifier of all the cells with the random access information is stored in NR ra-reportList in NR RRC variable VarRA-Report.

In an embodiment herein, the total number of NR RACH Reports send by the UE (100) does not exceed the maxNrofSNRAReports; i.e., the total number of NR RA-Report-r16 send by the UE (100) in sn-rach-report-List-r18 doesn't exceed maxNrofSNRAReport. For example, if one SN-RACH-Report contains 2 NR RA-Report-r16 and all other SN-RACH-Report contains 1 NR RA-Report-r16, number of SN-RACH-Report would be less than or equal to maxNrofSNRAReport−1.

Upon receiving the SN RACH-Report LIST, the eNB forwards the received OCTET STRING containing the RACH report to the gNB which has the associated PSCell. The gNB retrieves and decodes the NR-RACH-Report send by the eNB and performs self optimisation for the PSCells belonging to the gNB.

In an embodiment, the UE (100) sends the SN RACH-Report including a list of PSCell identifiers and an OCTET STRING containing NR (SN) RA Report. The list of PSCell identifiers include the PSCell identity of all the cells in NR RA Report. FIG. 9 is a flowchart depicting the process of generating and reporting SN RACH reports

The UE (100) encodes PSCell identifiers in LTE ASN.1 format and the NR RA Report is encoded in the NR ASN.1 format.

An example ASN.1 format for reporting SN RACH Reports according to LTE TS 36.331 based on above embodiment is given below.

UEInformationResponse-v1710-IEs ::= SEQUENCE {

| | |
|---|---|
| coarseLocationInfo-r17 | OCTET STRING |

OPTIONAL, nonCriticalExtension

```
    UEInformationResponse-v18xx-IEs
    OPTIONAL
}
UEInformationResponse-v18xx-IEs ::= SEQUENCE {
    sn-rach-report-r18 SN-RACH-Report-r18 OPTIONAL,
```

| | |
|---|---|
| nonCriticalExtension | SEQUENCE { } |

OPTIONAL

}

| | |
|---|---|
| SN-RACH-Report-r18 ::= | SEQUENCE { |

```
  nr-CellId-r18-list SEQUENCE (1..maxNrofSNRAReport) OF
  nr-CellId-r18,
```

| | |
|---|---|
| NR-RA-Report | OCTET STRING, |

}

| | |
|---|---|
| nr-CellId-r18 | CHOICE { |

| | |
|---|---|
| CellGlobalIdNR | CellGlobalIdNR-r16, |

| | |
|---|---|
| pci-arfcn-r18 | PCI-ARFCN-NR-r18 |

},
maxNrofSNRAReport := 8

The NR-RA-Report container contains an OCTET STRING which contains the entire SN NR-RACH Report List. Upon reception of the UE Information request requesting for the reporting of SN RACH Report, the UE (100) sets NR-RA-Report to an OCTET STRING containing the contents of ra-reportList in NR RRC variable VarRA-Report encoded in NR ASN.1 format.

The UE (100) includes the PSCell identifier for all the PSCells in the ra-reportList in NR RRC variable VarRA-Report, in nr-CellId-r18-list within SN RACH Report. The nr-CellId-r18-list is encoded in LTE ASN.1 format.

Upon receiving the SN RACH-Report, the eNB forwards the received NR RACH report to all the gNB(s) which contains at least one PSCell (at least one nr-CellId-r18) in the list of PSCell identifiers (nr-CellId-r18-list). The gNB retrieves and decodes the NR-RACH-Report send by the eNB and performs selfoptimization for the PSCells belonging to the gNB.

In an embodiment, the UE (100) includes the SN RA Report without including any PSCell Identifier. The UE (100) directly includes NR RA Report list (such as NR IE RA-ReportList-r16) in the UE information Response without associating to any cell identifier.

An example specification extract is given below:

UEInformationResponse-v1710-IEs ::= SEQUENCE {

| | |
|---|---|
| coarseLocationInfo-r17 | OCTET STRING |

OPTIONAL, nonCriticalExtension

```
  UEInformationResponse-v18xx-IEs
  OPTIONAL
}
UEInformationResponse-v18xx-IEs ::= SEQUENCE {
```

| | | |
|---|---|---|
| NR-RA-Report | OCTET | STRING |

OPTIONAL,

| | |
|---|---|
| nonCriticalExtension | SEQUENCE { } |

OPTIONAL

}

Upon reception of UE Information request requesting for the reporting of SN RACH Report, the UE (100) sets NR-RA-Report to an OCTET STRING containing the contents of ra-reportList in NR RRC variable VarRA-Report encoded in NR ASN.1 format.

FIG. 2 shows various hardware components of the UE (100), according to the embodiments as disclosed herein. In an embodiment, the UE (100) includes a processor (110), a communicator (120), a memory (130) and a SN RACH reporting controller (140). The processor (110) is coupled with the communicator (120), the memory (130) and the SN RACH reporting controller (140).

The SN RACH reporting controller (140) informs to the network entity (200), that the UE (100) is capable of a delivery of the at least one SN RACH report to the network entity (200). Further, the SN RACH reporting controller (140) receives the request from the network entity (200). In an embodiment, the request can be the UE Information Request. The UE Information Request is a LTE RRC message UE InformationRequest. The UE Information Request includes the field to indicate whether the UE (100) reports information about a random access procedure in a SN. In an embodiment, an information is provided within a list of SON parameters in the UE Capability Information LTE RRC message. Further, the SN RACH reporting controller (140) determines that the UE (100) has stored the at least one SN RACH report (e.g., NR RACH report or the like). Further, the SN RACH reporting controller (140) sends the at least one SN RACH report to the network entity (200) based on the request and the determination.

In an embodiment, the SN RACH reporting controller (140) sends the SN RACH report by including the RA report in the SN RACH report in the UE information response, upon reception of the UE information request including a request to send the SN RACH report to the network entity (200), when the UE (100) has a SN random access related information stored in the NR RRC variable and if the RPLMN is included in a plmn-IdentityList stored in the NR RRC variable.

In an embodiment, the SN RACH reporting controller (140) sends the SN RACH Report including the list of PSCell identifiers and an OCTET STRING containing a NR RA Report. The list of PSCell identifiers includes the PSCell identity of all cells in the NR RA Report.

In an embodiment, the SN RACH reporting controller (140) encodes the list of PSCell identifiers in a LTE ASN.1 format. The NR RA report is encoded in a NR ASN.1 format. In an embodiment, the PSCell identifier includes at least one of: a Cell-GlobalIdentifier of the PSCell, a NR PCI and a NR ARFCN of the PSCell where each PSCell identifier is encoded in a LTE ASN.1 format.

In an embodiment, when the dual connectivity is with the NR and 6G where the NR is the MN, the list of PSCell identifiers are in NR ASN.1 format and 6G RAT reports are encoded in the ASN.1 format of 6G. In general, the list of PSCell identifiers are encoded in MN ASN.1 format and the RACH report is in SN ASN.1 format. UE sends it capability for reporting SN RACH reports to MN and MN sends the request to report the SN RACH reports using MN UE information procedure and forwards to the SN's depending on the PSCells.

The SN RACH reporting controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the UE (100) and with external devices via one or more networks.

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 3 shows various hardware components of the network entity (200), according to the embodiments as disclosed herein. In an embodiment, the network entity (200) includes a processor (210), a communicator (220), a memory (230) and a SN RACH reporting controller (240). The processor (210) is coupled with the communicator (220), the memory (230) and the SN RACH reporting controller (240).

The SN RACH reporting controller (240) send the request to the UE (100). Further, the SN RACH reporting controller (240) receives the SN RACH reporting in the SON parameter from the UE (100) based on the request. Further, the SN RACH reporting controller (240) forwards the received SN RACH reporting to at least one second network entity (200), where the received SN RACH reporting includes at least one PSCell in a list of PSCell identifiers.

The SN RACH reporting controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

In an embodiment, the communicator (220) includes an electronic circuit specific to a standard that enables wired or wireless communication. The communicator (220) is configured to communicate internally between internal hardware components of the UE (100) and with external devices via one or more networks.

Although the FIG. 3 shows various hardware components of the network entity (200) but it is to be understood that other embodiments are not limited thereon. In other embodiments, the network entity (200) may include less or more number of components. Further, the labels or names of the components are used only for illustrative purpose and does not limit the scope of the invention. One or more components can be combined together to perform same or substantially similar function in the network entity (200).

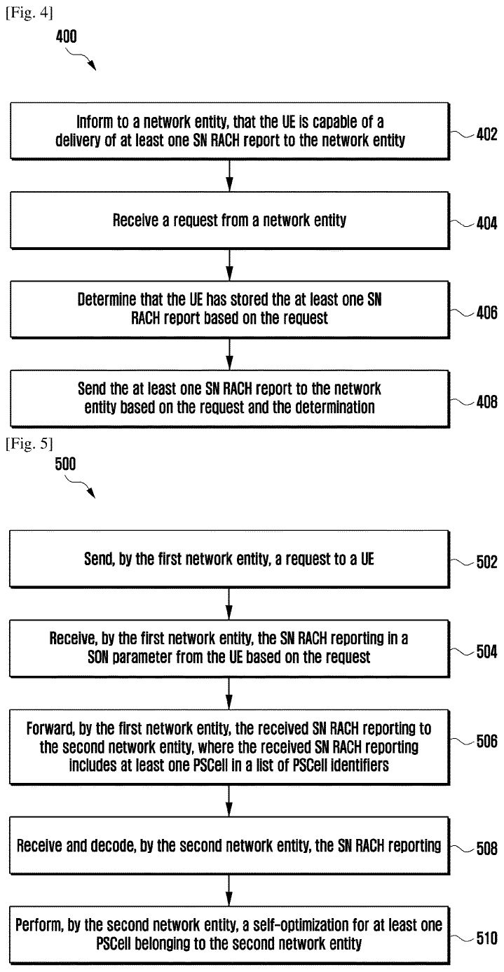

FIG. 4 is a flow chart (400) illustrating a method, implemented by the UE (100), for handling the SN RACH reporting in the wireless network (300), according to the embodiments as disclosed herein. The operations (402-408) are handled by the SN RACH reporting controller (140).

At 402, the method includes informing by the UE (100) to the network entity (200), that the UE (100) is capable of the delivery of the SN RACH report to the network entity (200). At 404, the method includes receiving the request from the network entity (200). At 406, the method includes determining that the UE (100) has stored the at least one SN RACH report based on the request. At 408, the method includes sending the SN RACH report to the network entity (200) based on the request and the determination.

FIG. 5 is a flow chart (500) illustrating a method for handling the SN RACH reporting in the wireless network (300), according to the embodiments as disclosed herein. The operations (502-506) are handled by the first network entity.

At 502, the method includes sending the request to the UE (100). At 504, the method includes receiving the SN RACH reporting in a SON parameter from the UE (100) based on the request. At 506, the method includes forwarding the received SN RACH reporting to the at least one second network entity (200). The received SN RACH reporting includes at least one PSCell in a list of PSCell identifiers.

The operations (508-510) are handled by the second network entity, At 508, the method includes receiving and decoding the SN RACH reporting. At 510, the method includes performing the self-optimization for at least one PSCell belonging to the second network entity (200). The second network entity is the gNB and the first network entity (200) is an eNB.

FIG. 6 is a flowchart depicting the process of reporting SN RACH information to the network entity (200) (e.g., eNB or the like), according to embodiments as disclosed herein. At Step 1, the UE (100) receives the UE information request including the SN-rach-reportreq from the network entity (200). At Step 2, the UE (100) create the SN RACH Report from the stored NR variable VarRA-Report. At Step 3, the UE (100) sends the UE Information Response including the SN RACH Report to the network entity (200).

FIG. 7-FIG. 9 are flowcharts (700-900) depicting the process of generating and reporting SN RACH reports, according to embodiments as disclosed herein.

As shown in FIG. 7, the operations (702-706) are handled by the SN RACH reporting controller (140). At step 702, the method includes receiving the UE information request requesting for SN RACH reporting. At step 704, the method includes generating the SN RACH-Report including the PSCell identifier in LTE ASN.1 format and a container with the entire SN NR-RACH Report List in NR ASN.1 format. At step 706, the method includes sending the SN RACH Report to the eNB in the UE InformationResponse message.

As shown in FIG. 8, the operations (802-806) are handled by the SN RACH reporting controller (140). At step 802, the method includes receiving the UE Information Request requesting for SN RACH Reporting. At step 804, the method includes generating the SN RACH-Report including the list of PSCell identifiers and the list of NR RA report containers associated with each PSCell identity. At step 806, the method includes sending the SN RACH Report to the eNB in the UE InformationResponse message.

As shown in FIG. 9, the operations (902-906) are handled by the SN RACH reporting controller (140). At step 902, the method includes receiving the UE Information Request requesting for SN RACH Reporting. At step 904, the method includes generating the SN RACH-Report including the list of PSCell identifiers and the container with the entire SN NR-RACH Report List in NR ASN.1 format. At step 906, the method includes sending SN RACH Report to the eNB in UE InformationResponse message.

The various actions, acts, blocks, steps, or the like in the flow charts (400, 500, and 700-900) may be performed in the order presented, in a different order or simul-taneously. Further, in some embodiments, some of the actions, acts, blocks, steps, or the like may be omitted, added, modified, skipped, or the like without departing from the scope of the invention.

Embodiments herein have been explained using 5G and associated modules (gNB, NR, UE (100)), however, it may be obvious to a person of ordinary skill in the art that embodiments herein can be extended to any network/technology (6G, and so on) and associated components (i.e., gNB can be any network node, and the UE (100) can be of any technology/network and so on).

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1-15. (canceled)

16. A method of a user equipment (UE) in a communication system, the method comprising:
transmitting, to a base station of a first radio access technology (RAT), capability information including an indication that the UE supports reporting of random access channel (RACH) information for a second RAT;
receiving, from the base station, a request message including information indicating that the UE is to report the RACH information for the second RAT; and
in case that the RACH information for the second RAT is stored in the UE and in case that a registered public land mobile networks (RPLMN) is included in a PLMN identifier (ID) list stored in the UE, transmitting, to the base station, a response message including the RACH information for the second RAT.

17. The method of claim 16,
wherein the RACH information for the second RAT includes a list of a random access report for the second RAT,
wherein the response message further includes a list of cell ID for the second RAT, the cell ID for the second RAT being stored in the random access report for the second RAT, and
wherein the random access report for the second RAT includes information on random access attempts for the second RAT.

18. The method of claim 17,
wherein the list of the cell ID for the second RAT includes a cell global ID or a physical cell identity (PCI) absolute radio frequency channel number (ARFCN), and
wherein the list of the random access report for the second RAT and the list of the cell ID for the second RAT are transmitted from the base station of the first RAT and the base station of the second RAT.

19. The method of claim 16,
wherein the first RAT is an evolved universal terrestrial radio access network (E-UTRAN), and
wherein the second RAT is a new radio (NR).

20. A method of a base station of a first radio access technology (RAT) in a communication system, the method comprising:
receiving, from a user equipment (UE), capability information including an indication that the UE supports reporting of random access channel (RACH) information for a second RAT;
transmitting, to the UE, a request message including information indicating that the UE is to report the RACH information for the second RAT; and
in case that the RACH information for the second RAT is stored in the UE and in case that a registered public land mobile networks (RPLMN) is included in a PLMN identifier (ID) list stored in the UE, receiving, from the UE, a response message including the RACH information for the second RAT.

21. The method of claim 20,
wherein the RACH information for the second RAT includes a list of a random access report for the second RAT,
wherein the response message further includes a list of cell ID for the second RAT, the cell ID for the second RAT being stored in the random access report for the second RAT, and
wherein the random access report for the second RAT includes information on random access attempts for the second RAT.

22. The method of claim 21, further comprising:
transmitting, to a base station of the second RAT, the list of the random access report for the second RAT and the list of the cell ID for the second RAT,
wherein the list of the cell ID for the second RAT includes a cell global ID or a physical cell identity (PCI) absolute radio frequency channel number (ARFCN).

23. The method of claim 20,
wherein the first RAT is an evolved universal terrestrial radio access network (E-UTRAN), and
wherein the second RAT is a new radio (NR).

24. A user equipment (UE) in a communication system, the UE comprising:
a transceiver, and
a controller coupled with the transceiver configured to:
transmit, to a base station of a first radio access technology (RAT), capability information including an indication that the UE supports reporting of random access channel (RACH) information for a second RAT,
receive, from the base station, a request message including information indicating that the UE is to report the RACH information for the second RAT, and
in case that the RACH information for the second RAT is stored in the UE and in case that a registered public land mobile networks (RPLMN) is included in a PLMN identifier (ID) list stored in the UE, transmit, to the base station, a response message including the RACH information for the second RAT.

25. The UE of claim 24,
wherein the RACH information for the second RAT includes a list of a random access report for the second RAT,
wherein the response message further includes a list of cell ID for the second RAT, the cell ID for the second RAT being stored in the random access report for the second RAT, and
wherein the random access report for the second RAT includes information on random access attempts for the second RAT.

26. The UE of claim 25,
wherein the list of the cell ID for the second RAT includes a cell global ID or a physical cell identity (PCI) absolute radio frequency channel number (ARFCN), and
wherein the list of the random access report for the second RAT and the list of the cell ID for the second RAT are transmitted from the base station of the first RAT and the base station of the second RAT.

27. The UE of claim 24,
wherein the first RAT is an evolved universal terrestrial radio access network (E-UTRAN), and
wherein the second RAT is a new radio (NR).

28. A base station of a first radio access technology (RAT) in a communication system, the base station comprising:
a transceiver, and
a controller coupled with the transceiver configured to:
receive, from a user equipment (UE), capability information including an indication that the UE supports reporting of random access channel (RACH) information for a second RAT,
transmit, to the UE, a request message including information indicating that the UE is to report the RACH information for the second RAT, and
in case that the RACH information for the second RAT is stored in the UE and in case that a registered public land mobile networks (RPLMN) is included in a PLMN identifier (ID) list stored in the UE, receive, from the UE, a response message including the RACH information for the second RAT.

29. The base station of claim 28,
wherein the RACH information for the second RAT includes a list of a random access report for the second RAT,
wherein the response message further includes a list of cell ID for the second RAT, the cell ID for the second RAT being stored in the random access report for the second RAT, and
wherein the random access report for the second RAT includes information on random access attempts for the second RAT,
wherein the controller is further configured to transmit, to a base station of the second RAT, the list of the random access report for the second RAT and the list of the cell ID for the second RAT, and
wherein the list of the cell ID for the second RAT includes a cell global ID or a physical cell identity (PCI) absolute radio frequency channel number (ARFCN).

30. The base station of claim 28,
wherein the first RAT is an evolved universal terrestrial radio access network (E-UTRAN), and
wherein the second RAT is a new radio (NR).
